(19) United States
(12) Patent Application Publication
(10) Pub. No.: US 2017/0059452 A1
(43) Pub. Date: Mar. 2, 2017

(54) ROLLER-TYPE TEST STAND, AND OPERATING METHOD FOR A ROLLER-TYPE TEST STAND

(71) Applicant: KNORR-BREMSE SYSTEME FUR SCHIENENFAHRZEUGE GMBH, Munchen (DE)

(72) Inventors: Marcus FISCHER, Munchen (DE); Jorg KOCH, Munchen (DE); Detlev ULLRICH, Berlin (DE); Andreas FESTEL, Sparneck (DE)

(73) Assignee: KNORR-BREMSE SYSTEME FUR SCHIENENFAHRZEUGE GMBH, Munchen (DE)

(21) Appl. No.: 15/307,477

(22) PCT Filed: Apr. 27, 2015
(86) PCT No.: PCT/EP2015/059021

§ 371 Date: Oct. 28, 2016

(30) Foreign Application Priority Data
Apr. 30, 2014 (DE) 10 2014 106 086.5

(51) Int. Cl. G01M 17/10

(52) U.S. Cl. CPC G01M 17/10

(57) ABSTRACT

An operating method for a roller-type test stand for a rail vehicle wheel set, in particular for simulating a sinusoidal run, has two parallel rail rollers, and the wheel set has two wheels which are connected to a wheel axle. The ends of the wheel axle are rotatably mounted in a first axle bearing and a second axle bearing. The wheels are in contact with the rail rollers in a respective base position of the axle bearings at a respective specified point of the rail rollers, and a first longitudinal actuator and a second longitudinal actuator each act on the first axle bearing or the second axle bearing in a longitudinal direction running transversely to the wheel axle.

### CROSS REFERENCE AND PRIORITY

### Priority Paragraph

This patent application is a U.S. National Phase of International Patent Application No. PCT/EP2015/059021, filed Apr. 27, 2015, which claims priority to German Patent Application No. 10 2014 106 086.5, filed 30 Apr. 2014, the disclosure of which are incorporated herein by reference in their entirety.

### FIELD

Disclosed embodiments relate to a roller-type test stand for a wheel set for a rail vehicle, in particular for simulating a sine run, and to an operating method for such a roller-type test stand. The roller-type test stand has two rail rollers which are arranged in parallel, and are, in particular, rotatable, in particular with a rail-typical or rail road rail-typical profile, which rail rollers are connected to one another, in particular, rigidly or by means of a transmission mechanism at a defined relative speed. In addition, the roller-type test stand has a first longitudinal actuator and a second longitudinal actuator. The wheel set which is used in the operating method has two wheels which are connected, in particular, rigidly to a wheel axle, in particular with a rail vehicle-typical or rail road rail vehicle-typical wheel profile. The wheel axle is rotatably mounted by its ends in a first and a second axle bearing, wherein in a respective base position of the axle bearings the wheels are respectively in contact with the rail rollers at a predetermined point of the rail rollers, in particular the upper vertex. The first and the second longitudinal actuator each act in a longitudinal direction, running transversely with respect to the wheel axle and, in particular, at least essentially horizontally, on the first or second axle bearing.

### BACKGROUND

The travel properties of rail vehicles, in particular of possible accelerations and decelerations, are decisively influenced by the contact between the wheel and the rail. This contact is influenced mainly by the frictional properties of the wheel and the rail and possibly present intermediate layers and the slip between the wheels and the rail. The most accurate possible knowledge of the contact between the wheel and rail permits the travel properties and the braking properties to be optimized and permits optimum configuration of bogies, drivers and/or brake systems.

In addition to real travel tests on the rail and simulations with different mathematical models, roller-type test stands provide the possibility of being able to carry out vehicle-movement-dynamics investigations or load trials reliably with reproduceable results. In particular, it is possible to represent extreme travel states which are too dangerous during normal operations on the rail or are unacceptable for other reasons.

The results of investigations on roller-type test stands are more informative and more valuable the truer to reality the modelling of the movement sequences between the wheel set and rail can be. In the case of a rail road-typical wheel profile, the running wheels usually have an outwardly tapering profile. In addition, a wheel flange is provided on the inner edge of the wheel. The profile causes a wheel which is offset outward in the axial direction to roll with a larger circumference on the rail than a wheel which is offset inward towards the center of the track. Since the two wheels are connected, in particular rigidly, by their axle, when the wheel set is deflected out of the center of the track the wheel which is offset inward stays back with respect to the one which is offset outward, with the result that the wheel axle turns inward in terms of the track with respect to the direction of travel, about a rotational axis which extends at least essentially vertically upwards through the center point of the axle. As a result of this rotation of the wheel axle, the wheel which is firstly offset inward then runs outward, and correspondingly the wheel which is firstly offset outward runs inward, with the result that the wheel set experiences an opposing deflection beyond the center of the track, during which deflection the process described above repeats with a reversed sign.

These vehicle movement dynamics result in a lateral oscillating movement of the entire wheel axle. This oscillating movement is referred to as sine run, since in a first approximation it follows a sine curve. With reference to the periodically oscillating rotational movement of the wheel axle about the vertical rotational axis, these vehicle movement dynamics are also referred to as a tumbling movement. Of course, both phenomena, the periodic lateral deflection of the wheel set and the periodic rotation of the wheel axle, are different aspects of the same process. In this sense, for the sake of simplification, just one term, specifically the sine run, is used for this process throughout, with both phenomena being included.

For roller-type test stands of the type mentioned at the beginning it is known to impress in a forced fashion a sine run based on simulation calculations, by means of corresponding travel control of a transverse actuator and/or the two longitudinal actuators. Natural movement of the wheel set on the rail rollers is, however, suppressed here or has the impressed movement superimposed on it. In particular the forces which occur in the wheel/rail system, in particular in the contact part between the wheel and rail, merely constitute a superimposition of the forces occurring as a result of the impressed sinusoidal movement on the natural forces.

### SUMMARY

Disclosed embodiments provide an operating method for a roller-type test stand in which investigations can be carried out in a way which is as close or true to reality as possible, in particular using a sine movement which is as natural as possible. A further object is to specify a roller-type test stand which is suitable for carrying out the method.

An inventive operating method of the type mentioned at the beginning is defined by the fact that the first longitudinal actuator which acts on the first axle bearing is operated under force control, and a deflection of the first axle bearing in the longitudinal direction with respect to its base position is determined. The second longitudinal actuator which acts on the second axle bearing is operated under travel control, in such a way that a deflection of the second axle bearing is set with respect to its base position, which deflection corresponds in absolute terms to the deflection of the first axle bearing and is opposed to the deflection of the first axle bearing in the longitudinal direction.

This ensures that the wheel set can rotate about a vertical rotational axis without the center point of the wheel set, i.e. the center between the two wheels or axle bearings, moving away from its base position in the longitudinal direction, in particular precisely above the rail roller axis. The deviation of the two wheels from the predefined points, in particular from the upper vertices of the rail rollers, is always zero in the center. Nevertheless, it is possible here for the first longitudinal actuator to be adjusted in a freely selectable way to a force set point value or a force set point value profile. In contrast to the method known from the prior art the two longitudinal actuators are therefore not travel controlled but instead one of the two longitudinal actuators is force controlled and the other of the two longitudinal actuators is travel controlled. In contrast to the method known from the prior art, a sinusoidal profile is not impressed by corresponding travel control of the two longitudinal actuators but instead an at least approximately natural sine run of the wheel set is set automatically.

In one advantageous refinement of the operating method, in one operating mode the force control of the first longitudinal actuator is carried out to a predefined constant force. With a constant force equal to zero it is possible to simulate an undamped sine run in the case of straight-ahead travel, and with a constant force unequal to zero it is possible to simulate an undamped sine run in the case of travel around a bend.

A further advantageous refinement of the operating method can be used if the roller-type test stand additionally has a transverse actuator which, in a transverse direction running along the wheel axle and, in particular, at least essentially horizontally, acts on the first or second axle bearing. The transverse actuator which acts on the respective axle bearing—like the first longitudinal actuator—may be operated under force control. In particular, in an operating mode for simulating an undamped sine run in the case of straight-ahead travel or travel around a bend it is preferred if the force control of the transverse actuator is carried out to a predefined constant transverse force which is, in particular, equal or unequal to zero.

In a further advantageous refinement of the operating method, in a further operating mode the force control of the first longitudinal actuator and/or of the transverse actuator is carried out to a predefined time-variant force and/or transverse force which is applied by the first longitudinal actuator and has a damping component which is dependent on a change over time in the deflection of the first axle bearing in the longitudinal direction or on a deflections of the axle bearing which take place in the transverse direction with respect to a center position of the wheel set, on which axle bearing the transverse actuator acts. The result, a damped sine run in the case of straight-ahead travel or travel around a bend can be simulated.

Alternatively or in addition, the force control of the first longitudinal actuator and/or of the transverse actuator can be carried out to a predefined force and/or transverse force which is applied by the first longitudinal actuator and which has a component which is dependent on a deflection of the first axle bearing in the longitudinal direction or on a deflections of the axle bearing which take place in the transverse direction with respect to a center position of the wheel set, on which axle bearing the transverse actuator acts. As a result, for example dead travel values which are characteristic of mechanical spring-damper systems can be simulated.

According to one refinement of the disclosed embodiments, in particular of the start of the operating method, in particular to excite the sine run, at least one of the longitudinal actuators and/or the transverse actuator acts on the respective axle bearing with a pulse or an excitation pulse. Such a pulse can be used to deflect the wheel set at least slightly from its base position and therefore to initiate the sine run. The wheel set can also already be fitted onto the rail rollers originally outside the base position, in particular off center.

In further advantageous refinements of the operating method, at least for one of the actuators, a force, acting on the respective axle bearing, and/or acceleration are monitored, wherein a fault signal is output if the absolute value of the respective force and/or acceleration exceeds/exceed a respective predefined limiting value. When the fault signal is present, the roller-type test stand and/or the operating method is, at least partially, switched off. In particular, the rotating rail rollers and the wheels can be placed in a safe state, and, in particular, braked. In this way safety measures are taken to prevent uncontrolled movement of the wheel set.

The aforementioned object is also achieved by means of a further method in which both the first longitudinal actuator which acts on the first axle bearing and the second longitudinal actuator which acts on the second axle bearing are respectively operated under force control. Advantageous embodiments of the further method arise in an analogous fashion from the developments explained in conjunction with the first inventive method in the description, the drawing and/or the claims. In particular, the two longitudinal actuators can be operated in a fashion analogous to the force-controlled longitudinal actuator described in conjunction with the first inventive method.

An inventive roller-type test stand of the type mentioned at the beginning has a control device which is, in particular, connected to the first and second longitudinal actuator and, if appropriate, a transverse actuator and is configured to carry out the method specified above. The advantages mentioned in conjunction with the method are obtained.

### BRIEF DESCRIPTION OF FIGURES

Disclosed embodiments is explained in greater detail below with reference to the drawings, in which:

FIG. 1 shows a roller-type test stand in a schematic perspective illustration, and

FIG. 2 shows a flow chart of a method for operating a roller-type test stand.

### DETAILED DESCRIPTION

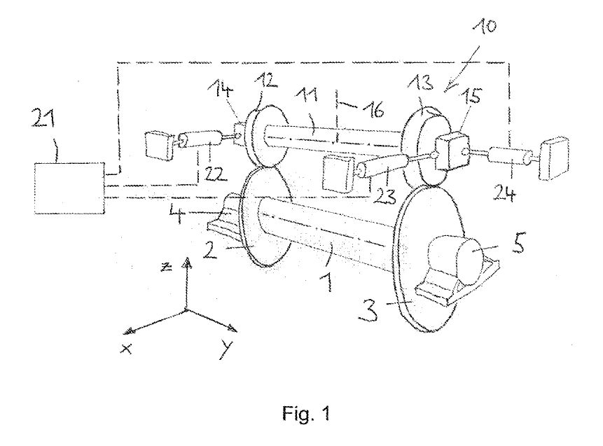

FIG. 1 shows an exemplary embodiment of a roller-type test stand in a schematic perspective illustration. The roller-type test stand is reduced to its essential elements which are relevant in the scope of the invention.

The roller-type test stand comprises a rail roller axis 1 with two rail rollers 2, 3 which are connected rigidly thereto. The rail roller axis 1 is rotatably mounted with bearings 4, 5. The rail roller axis 1 is coupled to a drive device (not illustrated here) by which the rail rollers 2, 3 can be made to move in rotation. The rail rollers 2, 3 have on their circumference a profile which is modelled on that of a rail system under consideration. The distance between the rail rollers 2, 3 corresponds to the gauge of the rail system. It is also conceivable to embody the roller-type test stand with a rail roller axial 1 which is connected to the rail rollers 2, 3 by means of at least one, in particular shiftable, transmission at a defined relative speed. The two rail rollers can, however, also be driven by two drives which are separate from one another, wherein a rotational speed ratio of the two rail rollers with respect to one another can be set to be equal or unequal to 1 by corresponding actuation means.

During the operation of the roller-type test stand, the rotatable rail rollers 2, 3 represent the rail which moves relative to the test specimen, the wheel set, in particular, the test wheel set. Such a wheel set is illustrated in FIG. 1, indicated by the reference 10.

The wheel set 10 comprises a wheel axle 11, in particular test wheel axle, to which a first wheel 12, in particular a test wheel, is rigidly connected in the outer region on one side, and a second wheel 13, in particular a test wheel, is rigidly connected on the opposite side. The wheel axle 11 is in each case mounted rotatably by its ends in a first axle bearing 14 on the side of the first wheel 12, and in a second axle bearing 15 on the side of the second wheel 13.

The wheel set 10 can be a running wheel set to be tested. In this case, a movement between the running wheel set and the rail is simulated by a drive of the rail roller axis 1 and therefore of the rail rollers 2, 3. The wheel set 10 can also be a traction wheel set which can be driven via a suitable separate drive device (not illustrated here). In this case, a movement of the traction wheel set with respect to the rail can be simulated by driving the wheels 12, 13 and/or by driving the rail rollers 2, 3. If the wheels 12, 13 and the rail rollers 2, 3 are driven, for example travel situations can be reconstructed in which slip is present between the wheel and the rail. In all specified cases, in addition a brake device can be arranged on the wheel set 10 to investigate the vehicle movement dynamics in the case of braking processes.

The roller-type test stand also comprises a control device 21 which is coupled to a first longitudinal actuator 22, a second longitudinal actuator 23 and a transverse actuator 24 and can operate these in a controlling fashion.

The first longitudinal actuator 22 is mechanically connected directly or indirectly to the first axle bearing 14, and is configured to apply a force Fx1 in the longitudinal direction (Fx1>0) or counter to the longitudinal direction (Fx1<0) to the first axle bearing 14. The longitudinal direction is shown in the co-ordinate system in FIG. 1 as an x direction. It runs horizontally and transversely, in particular perpendicularly, with respect to the orientation of the rail roller axis 1 or the wheel axle 11.

Analogously to this, the second longitudinal actuator 23 is mechanically coupled directly or indirectly to the second axle bearing 15. Direct coupling of the longitudinal actuators 22, 23 is provided, for example, if the longitudinal actuators 22, 23 act on a cross member which is connected to the axle bearings 14, 15. Spring systems and/or damper systems can be arranged between the axle bearings 14, 15 and the cross member.

Furthermore, a transverse actuator 24 is provided which acts on one of the two axle bearings, here, for example, the second axle bearing 15 and which is configured to apply a transverse force Fy in a transverse direction along the wheel axle 11 to the wheel set 10. The transverse direction in which the transverse actuator 24 acts is entered as a y direction in the co-ordinate system in FIG. 1. Alternatively, the transverse actuator can also act on a cross member.

The specified actuators may be hydraulic actuators, in particular hydraulic cylinders, but it is also possible to use electromechanically operating actuators. Force sensors and travel sensors which are integrated in the first and second longitudinal actuators 22, 23 and the transverse actuator 24 or interact therewith are not illustrated separately in FIG. 1. The respective force sensor detects, in particular, the force Fx1 or Fy which is applied to the axle bearing 14, 15 by the longitudinal actuator 22 and by the transverse actuator 24, and is communicated to the control device 21. For example strain sensors or piezo sensors can be used as force sensors.

The travel sensors correspondingly detect a movement of the first axle bearing 14 or of the second axle bearing 15 and also communicate it to the control device 21. The movements of the first axle bearing 14 or of the second axle bearing 15 in the longitudinal direction are referred to below as deflections Sx1 or Sx2, wherein the deflections are measured relative to a center position or base position at which the wheels 12, 13 made contact with the rail rollers 2, 3 at their upper vertex. The movement of the wheel set 10 in the transverse direction is referred to below as deflection Sy. The travel sensors can be, for example, optical sensors or sensors which operate by means of changes in resistance. It is also possible to use image-capturing systems, in particular cameras. In conjunction with hydraulically operating actuators it is possible also to determine travel by detecting the quantity of hydraulic fluid flowing into the actuator or out of it.

Optional further actuators, which act on the first and second axle bearings 14, 15 downward in the vertical direction, counter to the z direction in the figure are not illustrated in the figure. A static and/or dynamic load of the wheel set 10 during the test run can also be simulated by means of these actuators.

Disclosed embodiments, the control device 21 is designed to operate the first longitudinal actuator 22 under force control. Furthermore, the control device 21 is designed to detect the deflection Sx1 of the first axle bearing 14 and to control the longitudinal actuator 22 acting on the second axle bearing 15 in such a way that the deflection Sx2 of the second axle bearing 15 is as large in absolute terms as the deflection Sx1 of the first axle bearing 14, but points in the opposite direction, that is to say the following applies: Sx2=−Sx1. This permits the wheel set 10 to be able to rotate about a vertical rotational axis 16 without the center point of the wheel axle 11 moving away in the longitudinal direction from its position precisely above the rail roller axis 1. A natural sine run of the wheel set 10 can be set in which the deviation of the wheels 12, 13 averaged over time from the vertices of the rail rollers 2, 3 tends toward zero or is equal to zero.

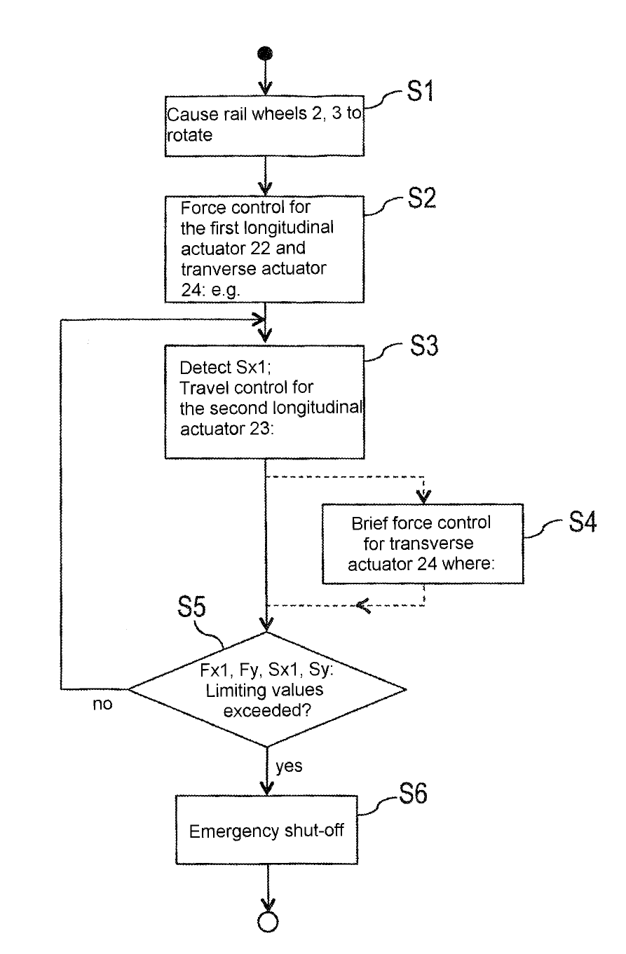

An operating method for a roller-type test stand according to various operational modes, as explained, for example, by the roller-type test stand in FIG. 1, is illustrated below using a flow chart in FIG. 2, to facilitate various travel situations. The operating method is described with respect to FIG. 1 and using the reference numbers in FIG. 1.

At S1, a test run for a running wheel set as a wheel set 10 is started by firstly securing the longitudinal actuators 22, 23 and the transverse actuator 24 or the axle bearings 14, 15 in the base position, and causing the rail wheels 2, 3 to rotate by means of their drive. After a rotation frequency which is provided is reached, the method is continued at S2.

At S2, the control device 21 switches over to a force control mode for the first longitudinal actuator 22 and the transverse actuator 24. During the force control, the corresponding forces Fx1 and Fy are detected, and the first longitudinal actuator 22 and the transverse actuator 24 are controlled in such a way that the predefined set point values F0x1, F0y of the force are complied with. In order for example, to simulate a travel situation in the straight track, the two set point values of the forces are set to F0x1=F0y=0.

At S3, the deflection Sx1 of the first axle bearing 14 is detected, and the second longitudinal actuator 23 is controlled in such a way that the following applies for the deflection Sx2 of the second axle bearing 15: Sx2=−Sx1. The second longitudinal actuator 23 is then actuated in travel control mode. The first longitudinal actuator 22 and the transverse actuator 24 remain in the previously set force control mode.

A sine run also occurs as soon as the wheel set 10 is deflected slightly from its base position. This occurs, in particular, once in a at S4, may as a result of a brief deflection pulse by the transverse actuator 24 in that a set point value for the force F0y≠0 is predefined briefly in the force control mode or in that the transverse actuator 24 is taken briefly out of the force control mode.

At S5, the current values for the forces Fx1, Fx2 and Fy as well as the deflections Sx1, Sx2 and Sy are compared with the predefined limiting values. If the values are below the limiting values, the method branches back to S3, which is then carried out alternatively with S5 or in parallel therewith. If one of the values is above the corresponding limiting value, the method is continued in a at S6.

At S6, an emergency shut-off of the roller-type test stand is carried out. Safety measures are taken to prevent an uncontrolled movement of the wheel set 10. For example, all the actuators 22, 23, 24 can be switched to a travel control mode to return the wheel set 10 to its base position. In addition, the rotation speed of the drive of the rail wheels 2, 3 is reduced or the drive is stopped. A safe state can also be brought about by raising the wheel set 10.

In an alternative operating mode, at S2 a constant value Fy≠0 is applied to the transverse actuator 24. This force which acts in or counter to the transverse direction simulates the transverse acceleration, occurring as a result of travel around a bend, of the rail vehicle or the track guiding force in the case of cornering. In addition or alternatively to this, it is possible to provide for a constant set point value F0x1 to be predefined for the force Fx1≠0 for the first longitudinal actuator 22. A force Fx1≠0 corresponds to the yawing moment of a, for example, two-axle bogie. In this way, a sine run is formed for a wheel set which is under force influences, such as are typical for travel around a bend. The wheel set 10 will possibly start laterally and be at a specific starting angle, but will nevertheless exhibit the vehicle movement dynamics which are typical for the predefined constraining forces.

In a further operating mode of the method there is provision that the forces Fx1 and Fy which act on the wheel set 10 from the first longitudinal actuator 22 and/or the transverse actuator 24 are not to be kept constant but instead provided with a component which is dependent on a change over time in the deflection Sx1 of the first axle bearing 14 or on the deflection Sy of the second axle bearing 15. The force Fx1 can be controlled here according to the following formula:

Fx1(t)=F0x1−qd/(Sx1(t))/dt.

A force Fx1(t) occurs which is dependent on the time t and which results from the predefined constant set point value F0x1 and a term which is dependent on the change over time in the deflection Sx1, that is to say the speed of the axle bearing 14. Damping is therefore introduced whose magnitude can be set by means of a damping constant q.

Analogously, the force Fy can be controlled according to the following formula:

Fy(t)=F0y−pd(sy(t))/dt,

where the magnitude of the damping can again be set by means of a damping constant p. The damping values can be set, for example, by means of a electronically adjustable controller.

Furthermore, it is possible to predefine the forces Fx1 and Fy directly as a function of the magnitude of the respective deflection Sx1 or Sy, for example in that the forces do not assume the constant (or damped) set point value F0x1 or F0y, and are below the limiting value zero, until a specific predefined deflection is exceeded. In this way idle travel is introduced which is characteristic of mechanical spring-damper systems.

In this way, the movement behavior and damping behavior of a single wheel set can be simulated in the test stand and without a bogie or a complete rail vehicle having to be used. The damping constants p and q and possible idle travel are the characteristic values of anti-rolling devices, by means of which the lateral and transverse movements of the wheel set are damped in a vehicle. The advantage of such a test arrangement is that it can be used to model essential movement characteristics on the roller-type test stand purely electronically, and in this way the reaction of the wheel set to, for example, braking processes and driving processes, different contact conditions and changing profile pairings of the profiles of the rail and wheel can also be represented on the roller-type test stand. This does not require any mechanical attachments or modifications.

### LIST OF REFERENCE NUMBERS

1 Rail roller axis
2, 3 Rail roller
4, 5 Bearings
10 Wheel set
11 Wheel axle
12 First wheel
13 Second wheel
14 First axle bearing
15 Second axle bearing
16 Vertical rotational axis
21 Control device
22 First longitudinal actuator
23 Second longitudinal actuator
24 Transverse actuator

1. An operating method for a roller-type test stand for a wheel set for a rail vehicle, for simulating a sine run, wherein the roller-type test stand has two rail rollers which are arranged in parallel, the wheel set has two wheels which are connected to a wheel axle, wherein the wheel axle is rotatably mounted by its ends in a first axle bearing and a second axle bearing, in a respective base position of the axle bearings the wheels are respectively in contact with the rail rollers at a predefined point thereof, and a first longitudinal actuator and a second longitudinal actuator each act in a longitudinal direction, running transversely with respect to the wheel axle, on the first axle bearing or the second axle bearing, wherein, the first longitudinal actuator which acts on the first axle bearing is operated under force control, a deflection of the first axle bearing in the longitudinal direction with respect to its base position is determined, and the second longitudinal actuator which acts on the second axle bearing is operated under travel control, in such a way that a deflection of the second axle bearing is set with respect to its base position, which deflection corresponds in absolute terms to the deflection of the first axle bearing and is opposed to the deflection of the first axle bearing in the longitudinal direction.

2. The operating method of claim 1, wherein the predefined points are upper vertices of the rail rollers.

3. The operating method as claimed in claim 1, wherein one operating mode, in particular for simulating an undamped sine run in the case of straight-ahead travel or travel around a bend the force control of the first longitudinal actuator is carried out to a predefined constant force which is, in particular, equal or unequal to zero.

4. The operating method of claim 1, wherein one operating mode, in particular for simulating a damped sine run in the case of straight-ahead travel or travel around a bend the force control of the first longitudinal actuator is carried out to a predefined time-variant force which has a damping component which is dependent on a change over time in the deflection of the first axle bearing in the longitudinal direction.

5. The operating method of claim 4, wherein the time-variant force is given by the formula
Fx1(t)=F0x1−qd/(Sx1(t))/dt.
where Fx1(t) corresponds to the time-variant force, F0x1 corresponds to a constant, d(Sx1(t))/dt corresponds to the change over time in the deflection of the first axle bearing in the longitudinal direction, and q corresponds to a damping factor.

6. The operating method of claim 1, wherein a transverse actuator, which, in a transverse direction running along the wheel axle, acts on the first axle bearing or second axle bearing, is additionally provided on the roller-type test stand.

7. The operating method of claim 6, wherein the transverse actuator which acts on the respective axle bearing is operated under force control.

8. The operating method of claim 7, wherein one operating mode, in particular for simulating an undamped sine run in the case of straight-ahead travel or travel around a bend the force control of the transverse actuator is carried out to a predefined constant transverse force, which is, in particular, equal or unequal to zero.

9. The operating method of claim 7, wherein one operating mode, in particular for simulating a damped sine run in the case of straight-ahead travel or travel around a bend the force control of the transverse actuator is carried out to a predefined time-variant transverse force which has a damping component which is dependent on a change over time in a deflection, which takes place in the transverse direction with respect to by a center position of the wheel set, of the axle bearing on which the transverse actuator acts.

10. The operating method of claim 9, wherein the time-variant transverse force is given by the formula
Fy(t)=F0y−pd(Sy(t))/dt
where Fy(t) corresponds to the time-variant transverse force, F0y corresponds to a constant, d(Sy(t))/dt corresponds to the change over time in the deflection of the axle bearing, on which the transverse actuator acts, in the transverse direction, and p corresponds to a damping factor.

11. The operating method of claim 1, wherein, at least for one of the actuators, a force, acting on the respective axle bearing, and/or acceleration are monitored, wherein a fault signal is output if the absolute value of the respective force and/or acceleration exceeds/exceed a respective predefined limiting value.

12. The operating method of claim 11, wherein the fault signal is present the roller-type test stand and/or the operating method is, at least partially, switched off.

13. The operating method of claim 1, wherein both the first longitudinal actuator which acts on the first axle bearing and the second longitudinal actuator which acts on the second axle bearing are respectively operated under force control.

14. The roller-type test stand for a wheel set for a rail vehicle, for simulating a sine run, having two rail rollers which are arranged in parallel, and a first longitudinal actuator and a second longitudinal actuator, wherein
the roller-type test stand has a control device which is configured to carry out a method of claim 1.
